(19) United States
(12) Patent Application Publication
(10) Pub. No.: US 2006/0218650 A1
(43) Pub. Date: Sep. 28, 2006

(54) System and method for effectuating digital rights management in a home network

(75) Inventors: Jose Costa-Requena, Helsinki (FI); Immaculada Espigares, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/089,704

(22) Filed: Mar. 25, 2005

(51) Int. Cl. H04L 9/32

(52) U.S. Cl. 726/27

(57) ABSTRACT

A system for accessing protected content within an intranet includes a remote UI server capable of providing the remote user interface (UI) service, and a user entity capable of initiating the UI service with the remote UI server. In addition, the system includes a DRM agent capable of being accessed from the user entity over the remote UI service, where the DRM agent is located across the intranet from the control point. To effectuate modification of a rights object associated with a selected content item, the user entity is capable of operating the accessed DRM agent over the remote UI service. In this regard, the rights object is capable of being modified such that the selected content item can thereafter be accessed based upon the modified rights object.

### FIELD OF THE INVENTION

The present invention generally relates to digital rights management (DRM) systems and methods of and, more particularly, relates to DRM systems and methods of accessing protected content in a home network including a plurality of entities adapted to access such content.

### BACKGROUND OF THE INVENTION

In the emerging digital home, consumers are acquiring, viewing and/or managing an increasing amount of digital content, particularly media content like photographs, music and video media. In this regard, consumers are increasingly acquiring, viewing and/or managing such content on devices in a number of different domains, including consumer electronics (CE), mobile device and personal computer (PC) device domains. And as will be appreciated, consumers often desire to conveniently enjoy such content across different devices and locations in their homes, regardless of the source. In many homes, digital content is stored by a number of different devices, referred to as media servers by the Digital Living Network Alliance (DLNA) or Universal Plug and Play (UPnP), coupled to one another in a home network. These media servers include, for example, set-top boxes (STBs), personal video recorders (PVRs), PCs, stereo and home theaters that include non-volatile memory (e.g., music servers), broadcast tuners, video and imaging capture devices (e.g., cameras, camcorders, etc.), and/or multimedia mobile terminals (e.g., mobile telephones, portable digital assistants (PDAs), pagers, laptop computers, etc.). Also within many homes, digital content is rendered by a number of different devices, referred to as media players by the DLNA or UPnP. These devices, which are capable of providing content playback and rendering capabilities, may be co-located within or separate from one or more devices also including a media server. More particularly, for example, media players can comprise television monitors, stereo and home theaters, printers, multimedia mobile terminals, wireless monitors and/or game consoles. Further, homes may include one or more control point devices, which may be co-located with or separate from devices including media servers and/or media players. These control points may receive user commands for interacting with media servers and/or the media players for initiating and controlling the media transfer or rendering between the media servers and media players. More particularly, for example, a control point can comprise a television remote control, mobile telephone, PDA and/or PC.

In one of the more probable use cases for acquiring, viewing and/or managing digital content in the home, a user operates a home theater to browse and search content stored by a mobile terminal or another media server. After locating the desired content, then, the user can acquire, view and/or manage such content from the terminal/media server storing the content. For example, the user can then choose to download the content from the user's mobile terminal to the home theater, such as to view the content on the home theater.

As with the transfer and use of content in accordance with other conventional techniques, including cellular communication techniques, local transfer techniques and/or messaging techniques, there are some challenges with the protection of such content. Generally, conventional content protection can have several dimensions. In this regard, content can be protected by securing access to content. In such instances, the content may be available from content providers. Access to the content sources, however, can be controlled through, for example, firewalls, virtual private networks (VPNs) or the like. In addition to, or in lieu of, protecting access to content, content itself can be encrypted using any of a number of different encryption techniques, such as public key infrastructure (PKI) techniques. Further, content can be protected by using authentication schemes, as such are well known to those skilled in the art.

Whereas such techniques are adequate in protecting content delivered from a content provider to a destination (e.g., terminal), such techniques typically do not easily translate to transfer of the same content from the original destination to another device, such as to a media server (e.g., home theater). In this regard, gaining access rights to content typically requires the destination to connect to a rights issuer, such as the content provider, located outside the home network. In various instances, other devices receiving the content from the original destination require separate connectivity to the rights issuer, particularly when access rights are not bound to the content when downloaded to the respective devices. Conventionally, however, techniques do not exist for devices downloading content from the original destination to easily and efficiently receive access rights similar to those the original destination received from the rights issuer.

### SUMMARY OF THE INVENTION

In light of the foregoing background, embodiments of the present invention provide an improved system, digital rights management (DRM) entity, user entity, method and computer program product for accessing or otherwise facilitating access to protected content in an intranet, such as a home network. In accordance with embodiments of the present invention, an intranet includes a DRM entity such as a mobile terminal, PDA, personal computer or the like, where the DRM entity has or otherwise operates a DRM agent. The DRM agent is accessible from any of a number of different control points within the home network, such as in accordance with a remote user interface (UI) service. Thus, the DRM agent can be in communication with a remote UI server capable of providing the remote UI service to the control points within the home network. In various instances, the remote UI server is located within or outside the DRM entity including the DRM agent, where a secure connection can be established between the remote UI server and the DRM agent to thereby effectuate the remote UI service.

A control point can therefore communicate with a remote UI server to initiate a remote UI service. The control point can then access a DRM agent over the remote UI service, where the remote UI service permits the control point to more particularly access a UI of the respective DRM agent. Accordingly, the control points can use the remote UI service to operate the DRM agent to effectuate a modification in access rights to one or selected content items within content storage in the intranet. And further, if necessary, the DRM entity, or more particularly the DRM agent of the DRM entity, can be operated to communicate with a rights issuer outside the intranet to download the modified access rights. In this regard, the selected content items can be associated with metadata tags (e.g. ContentInfo, RightsInfo) including uniform resource identifiers (URIs) pointing to at least one of the DRM agent or remote UI server (providing the remote UI service for operating the DRM agent).

According to one aspect of the present invention, a system is provided for accessing protected content within an intranet. The system includes a remote UI server capable of providing the remote user interface (UI) service, and a user entity capable of initiating the UI service with the remote UI server. In addition, the system includes a DRM agent capable of being accessed from the user entity over the remote UI service, where the DRM agent is located across the intranet from the control point. To effectuate modification of a rights object associated with a selected content item, the user entity is capable of operating the accessed DRM agent over the remote UI service. In this regard, the rights object is capable of being modified such that the selected content item can thereafter be accessed based upon the modified rights object.

More particularly, the user entity can be capable of operating the DRM agent to download a modified rights object from a rights issuer, and thereafter bind the downloaded rights object to the selected content item. The user entity,. remote UI server and DRM agent may be located within the intranet, and may communicate with one another in accordance with a Universal Plug-and-Play (UPnP) architecture. And in various instances, the system further includes a rights issuer located outside the intranet, where the rights issuer is capable of communicating with the DRM agent. Accordingly, if necessary, the user entity can be capable of operating the DRM agent to download a modified rights object from a rights issuer located outside the intranet, such as in accordance with a Session Initiation Protocol (SIP) and/or Hypertext Transport Protocol (HTTP) architecture.

The system can further include an entity capable of verifying access rights of the entity with respect to the selected content item based upon the modified rights object. And if the access rights are verified, the entity can also be capable of accessing the selected content item. In this regard, the modified rights object can be bound to the selected content item in content storage located across the intranet from the entity. In such instances, the entity can be capable of accessing the selected content item from the content storage.

The user entity can more particularly include a control point that, when access rights to content transferred or otherwise streamed from the storage entity to the rendering entity, receives a notification indicating the failure of the rendering entity to render the content. Based upon the notification, the control point can discover a remote UI server bound to a DRM agent capable of managing the access rights. The control point can then operate the DRM agent over a remote UI service with the remote UI server to acquiring new rights or modify existing rights to thereby permit the rendering entity to access, and thus render, the content.

According to other aspects of the present invention, a DRM entity, user entity, method and computer program product are provided for accessing or otherwise facilitating access to protected content in an intranet. Embodiments of the present invention therefore provide an improved system, DRM entity, user entity, method and computer program product for accessing or otherwise facilitating access to protected content in an intranet. As indicated above, and explained below, the intranet includes a DRM agent that is accessible from a user entity, or more particularly a control point of a user entity, in accordance with a remote UI service. Thus, a control point can operate a DRM agent over the remote UI service, where the remote UI service permits the control point to more particularly access a UI of the respective DRM agent. By permitting the control point to operate the DRM agent, the control point can effectively effectuate a modification in access rights to one or selected content items including, if necessary or otherwise desired, communicating with a rights issuer outside the intranet. As such, the system, DRM entity, user entity, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for accessing or facilitating access to protected content, in accordance with to one embodiment of the present invention;

FIG. 2 is a block diagram of an entity capable of operating as one or more elements of the system of FIG. 1, in accordance with embodiments of the present invention;

FIG. 3 is a schematic block diagram of a mobile terminal, in accordance with one embodiment of the present invention;

FIG. 4 is a functional block diagram of a user entity facilitating a rendering entity accessing and thus rendering protected content, including effectuating a modification to access rights of the content to permit such an access, in accordance with embodiments of the present invention; and

FIGS. 5a and 5b are flowcharts illustrating various steps in a method of accessing protected content in an intranet, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

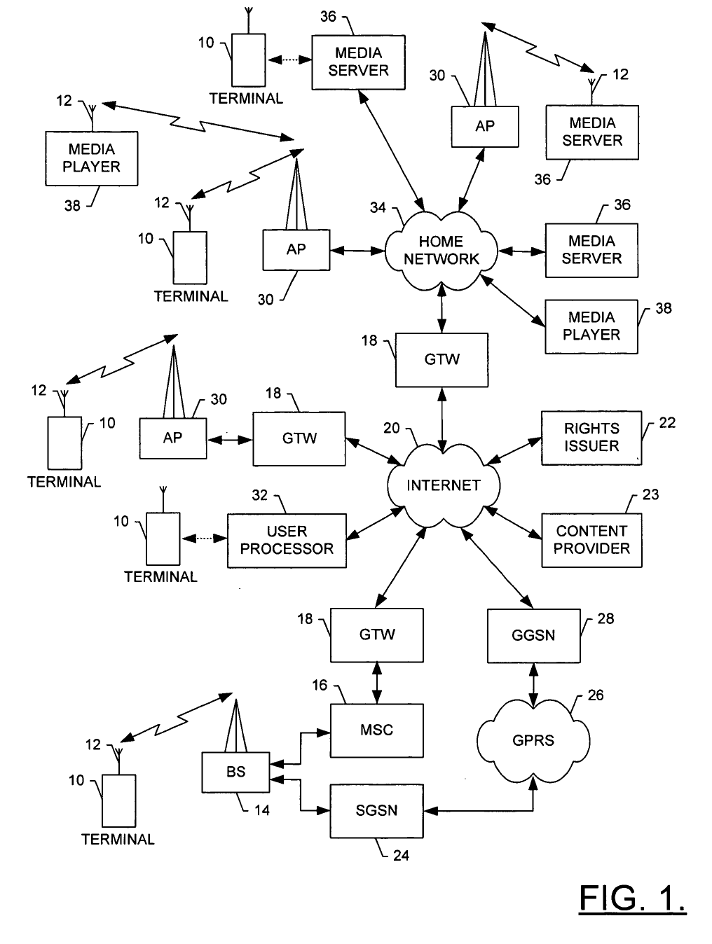

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of one or more cellular or mobile networks that each include elements required to operate the network, such as a mobile switching center (MSC) 16. The mobile network may also be referred to as a Base Station/MSC/Interworking function (BMI). In operation, the MSC is capable of routing calls to and from the terminal when the terminal is making and receiving calls. The MSC can also provide a connection to landline trunks such as, for example, when the terminal is involved in a call. In addition, the MSC can be capable of controlling the forwarding of messages to and from the terminal, and can also controlling the forwarding of messages for the terminal to and from a messaging center, such as short messaging service (SMS) messages to and from a SMS center (SMSC) (not shown).

The MSC 16 can be coupled to a data network, such as a personal area network (PAN), a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, the processing elements can include one or more processing elements associated with one or more rights issuers 22 and/or content providers 23, one of each being shown in FIG. 1.

The BS 14 can also be coupled to a signaling GPRS (General Packet Radio Service) support node (SGSN) 24. The SGSN is typically capable of performing functions similar to the MSC 16 for packet-switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28, and the GGSN is coupled to the Internet. Also, the GGSN can be coupled to a messaging center, such as a multimedia messaging service (MMS) center (not shown). In this regard, the GGSN and the SGSN, like the MSC, can be capable of controlling the forwarding of messages, such as MMS messages. The GGSN and SGSN can also be capable of controlling the forwarding of messages for the terminal to and from the messaging center. In addition, by coupling the SGSN 24 to the GPRS core network 26 and the GGSN 28, processing elements such as rights issuer(s) 22 and/or content provider(s) 23 can be coupled to the terminal 10 via the Internet 20, SGSN and GGSN. In this regard, devices such as rights issuer(s) and/or content provider(s) can communicate with the terminal across the SGSN, GPRS and GGSN.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode terminals (e.g., digital/analog or TDMA/CDMA/analog phones).

The terminal 10 can further be coupled to one or more wireless access points (APs) 30. The APs can comprise access points configured to communicate with the terminal in accordance with techniques such as, for example, radio frequency (RF), Bluetooth (BT), infrared (IrDA) or any of a number of different wireless networking techniques, including WLAN techniques as shown in FIG. 1. Additionally, or alternatively, the terminal can be coupled to one or more user processors 32. Each user processor can comprise a computing system such as a personal computer, laptop computer or the like. In this regard, the user processors can be configured to communicate with the terminal in accordance with techniques such as, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

The APs 30 and the user processors 32 may be coupled to the Internet 20. Like with the MSC 16, the APs and user processors can be directly coupled to the Internet. In one embodiment, however, the APs are indirectly coupled to the Internet via a GTW 18. As will be appreciated, by directly or indirectly connecting the terminals 10, rights issuer(s) 22 and/or content provider(s) 23, as well as any of a number of other devices, processors or the like, to the Internet, the terminals can communicate with one another, the rights issuer(s), content provider(s), etc., to thereby carry out various functions of the terminal, such as to transmit data, content or the like to, and/or receive content, data or the like from, the service providers and/or authorization managers.

In accordance with embodiments of the present invention, the Internet 20, and thus the terminal 10, can be coupled to one or more intranets. Each intranet can comprise one or more interlinked LANs, as well as portions of one or more PANs, LANs, MANs, WANs or the like. As shown in FIG. 1, at least one intranet generally comprises a private network contained within a home, such as in accordance with the Digital Living Network Alliance (DLNA) architecture and/or Universal Plug and Play (UPnP) architecture, as is accordingly referred to as a “home network” 34. As with the Internet, the home network can be coupled to devices such as processing elements which, in turn, can be coupled to the Internet and terminal via the home network. In addition, the home network can be coupled to one or more APs 30 capable of coupling processing elements, terminals and other devices to the home network. Within the home network, the devices can be configured to communicate with one another in a number of different manners, such as in accordance with the Universal Plug-and-Play (UPnP) architecture. Like various other components of the system, the home network, and thus the processing elements of the home network, is typically indirectly coupled to the Internet, and thus the terminal, via a GTW 18. Similarly, although not shown, each network or portion of a network included within the intranet can be interconnected with one another via a GTW.

More particularly, as shown in FIG. 1, processing elements such as media servers 36 and/or media players 38 can be coupled to the home network 34, and thus the terminal 10 via the AP 30. The media servers and media players can be coupled to the home network in any of a number of different manners. For example, one or more media servers and/or media players can be directly coupled to the home network. Additionally or alternatively, one or more of the media servers and/or media players can be indirectly coupled to the home network via an AP, the AP being the same as or different from the AP coupling the terminal to the home network.

The media servers 36 can comprise any of a number of different devices capable of providing content acquisition, recording, storage and/or sourcing capabilities. For example, in accordance with the DLNA architecture, the media servers can comprise set-top boxes (STBs), personal video recorders (PVRs), PCs, stereo and home theaters that include non-volatile memory (e.g., music servers), broadcast tuners, video and imaging capture devices (e.g., cameras, camcorders, etc.), and/or multimedia mobile terminals (e.g., mobile telephones, portable digital assistants (PDAs), pagers, laptop computers, etc.). The media players 38 can likewise comprise any of a number of different devices capable of providing content playback and rendering capabilities, and may be co-located within one or more devices also including a media server. For example, in accordance with the DLNA architecture, the media players can comprise television monitors, stereo and home theaters, printers, multimedia mobile terminals, wireless monitors and/or game consoles.

Irrespective of the specific device, one or more media servers 36 are capable of storing content capable of being rendered by one or more media players 38, and/or downloaded by a terminal 10 via the home network and the AP 30. Similarly, one or more media servers are capable of downloading content from a terminal via the home network and the AP. In this regard, the content can comprise any of a number of different types of content such as, for example, textual, audio, video and/or other types of multimedia content, software packages, applications, routines and/or other types of executable content.

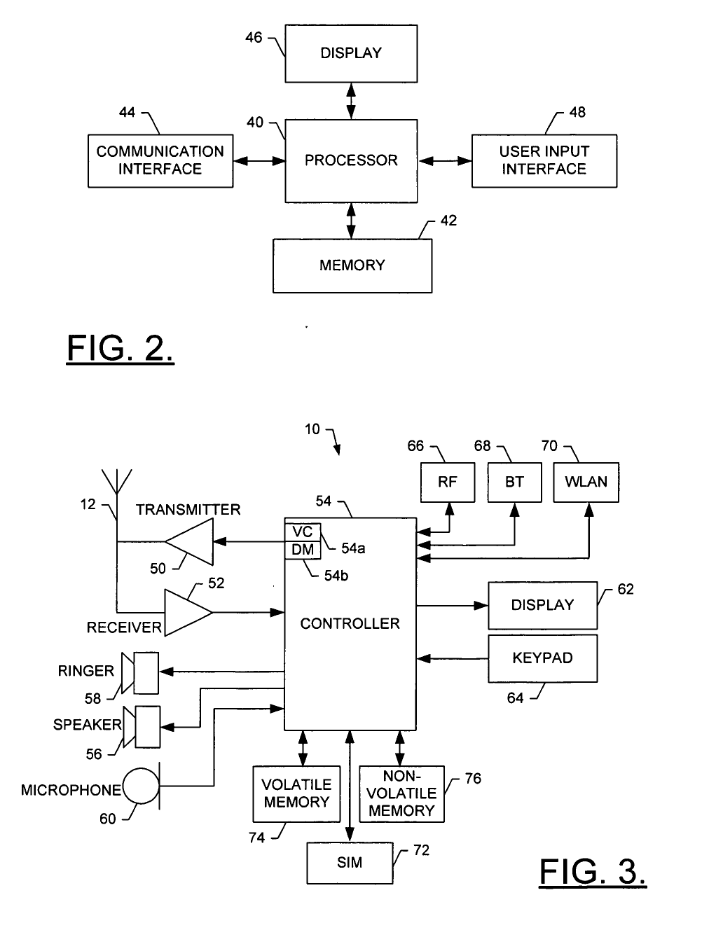

Reference is now made to FIG. 2, which illustrates a block diagram of an entity capable of operating as one or more elements of the system shown in FIG. 1 including, for example, a terminal 10, GTW 18, rights issuer 22, content provider 23, user processor 32, media server 36 and/or media player 38, is shown in accordance with one embodiment of the present invention. Although shown as separate entities, in some embodiments, one or more entities may support one or more of the terminal, GTW, rights issuer, content provider, user processor and/or media server, logically separated but co-located within the entit(ies). For example, a single entity (e.g., set top box) may or other entity may support a logically separate, but co-located, media server, media player and/or GTW. Also, for example, a single entity may support a logically separate, but co-located, rights issuer and content provider.

As shown, the entity capable of operating as a terminal 10, GTW 18, rights issuer 22, content provider 23, user processor 32, media server 36 and/or media player 38 can generally include a processor 40 connected to a memory 42. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

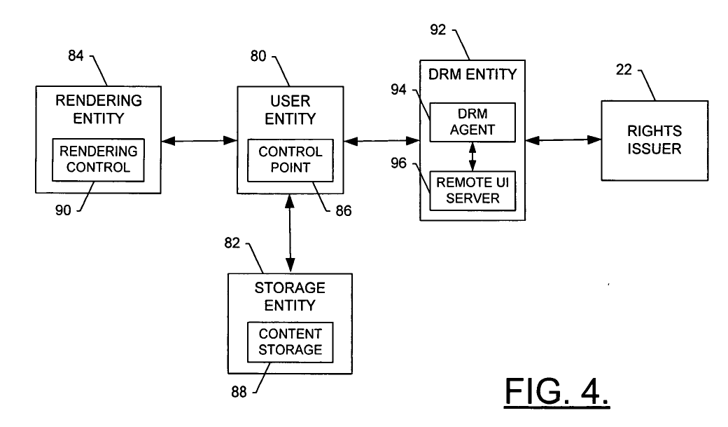

Reference is now drawn to FIG. 3, which illustrates a block diagram of a mobile terminal 10 in accordance with one embodiment of the present invention. As shown, in addition to the antenna 12, the mobile terminal can include a transmitter 50, receiver 52, and controller 54 or other processor that provides signals to and receives signals from the transmitter and receiver, respectively. These signals include signaling information in accordance with the air interface standard of the applicable cellular system, and also user speech and/or user generated data. In this regard, the mobile terminal can be capable of operating with one or more air interface standards, communication protocols, modulation types, and access types. More particularly, the mobile terminal can be capable of operating in accordance with any of a number of 1G, 2G, 2.5G and/or 3G communication techniques or the like.

It is understood that the controller 54 includes the circuitry required for implementing the audio and logic functions of the mobile terminal. For example, the controller may be comprised of a digital signal processor device, a microprocessor device, and various analog-to-digital converters, digital-to-analog converters, and/or other support circuits. The control and signal processing functions of the mobile terminal are allocated between these devices according to their respective capabilities. The controller can additionally include an internal voice coder (VC) 54a, and may include an internal data modem (DM) 54b. Further, the controller may include the functionally to operate one or more software programs, which may be stored in memory (described below). For example, the controller may be capable of operating a connectivity program, such as a conventional Web browser. The connectivity program may then allow the mobile terminal to transmit and receive Web content, such as according to the Hypertext Transfer Protocol (HTTP) and/or the Wireless Application Protocol (WAP), for example.

The mobile terminal also comprises a user interface including a conventional earphone or speaker 56, a ringer 58, a microphone 60, a display 62, and a user input interface, all of which are coupled to the controller 54. The user input interface, which allows the mobile terminal to receive data, can comprise any of a number of devices allowing the mobile terminal to receive data, such as a keypad 64, a touch display (not shown) or other input device. In embodiments including a keypad, the keypad includes the conventional numeric (0-9) and related keys (#, *), and other keys used for operating the mobile terminal. Although not shown, the mobile terminal can include a battery, such as a vibrating battery pack, for powering the various circuits that are required to operate the mobile terminal, as well as optionally providing mechanical vibration as a detectable output.

As indicated above, the mobile terminal 10 can also include one or more means for sharing and/or obtaining data, such as from AP(s) 30, user processor(s) 32, media server(s) 36, media player(s) 38 or the like. As shown in FIG. 3, the mobile terminal can include a RF module 66 capable of transmitting and/or receiving content from one or more media servers and/or media players directly or via the home network 34 and AP(s). In addition or in the alternative, the mobile terminal can include other modules, such as, for example an, a Bluetooth (BT) module 68 and/or a WLAN module 70 capable of transmitting and/or receiving data in accordance with Bluetooth and/or WLAN techniques, respectively.

The mobile terminal 10 can further include memory, such as a subscriber identity module (SIM) 72, a removable user identity module (R-UIM) or the like, which typically stores information elements related to a mobile subscriber. In addition to the SIM, the mobile terminal can include other removable and/or fixed memory. In this regard, the mobile terminal can include volatile memory 74, such as volatile random access memory (RAM) including a cache area for the temporary storage of data. The mobile terminal can also include other non-volatile memory 76, which can be embedded and/or may be removable. The non-volatile memory can additionally or alternatively comprise an EEPROM, flash memory or the like. The memories can store any of a number of pieces of information, and data, used by the mobile terminal to implement the functions of the mobile terminal. The memories can also store one or more applications capable of operating on the mobile terminal.

As explained in the background section, whereas conventional techniques are adequate in protecting content delivered from a content provider to a destination (e.g., terminal 10), such techniques typically do not easily translate to transfer of the same content from the original destination to another entity, such as to a media server 36 (e.g., home theater) and/or a media player 38 (e.g., television monitor). In this regard, gaining access rights to content typically requires the destination to connect to a rights issuer, such as the content provider, located outside the home network. In various instances, other entities receiving the content from the original destination require separate connectivity to the rights issuer, particularly when access rights are not bound to the content when downloaded to the respective entities. Conventional techniques, however, do not permit entities downloading or otherwise accessing content from the original destination to easily and efficiently receive access rights similar to those the original destination received from the rights issuer.

Embodiments of the present invention therefore provide an improved system and method for effectuating digital rights management (DRM) of protected content in a home network 34, where accessing such content may include communicating with a DRM agent to thereby extend or otherwise modify access rights to the protected content. Accordingly, embodiments of the present invention provide one or more DRM agents capable of directly or indirectly modifying access rights to protected content. The DRM agent can be accessible from any of a number of different control points within the home network, such as in accordance with a remote user interface (UI) service. Thus, the DRM agent can be in communication with a remote UI server capable of providing the remote UI service to the control points within the home network. Thus, a control point can communicate with a remote UI server to initiate a remote UI service. The control point can then access a DRM agent over the remote UI service, where the remote UI service permits the control point to more particularly access a UI of the respective DRM agent.

As will be appreciated, in various instances it may be necessary for a DRM agent to communicate with a rights issuer 22 outside of the home network 34 to thereby modify access rights to protected content. In such instances, by accessing the DRM agent over the remote UI service, a control point can further communicate with a rights issuer via the DRM agent over the remote UI service to thereby receive, from the rights issuer, additional or otherwise modified rights with respect to protected content. The control point can then effectuate binding the additional/modified rights to the protected content via the DRM agent. As such, embodiments of the present invention permit one or more control points to effectuate a modification of access rights to thereby modify the entities within the home network authorized to access the respective content.

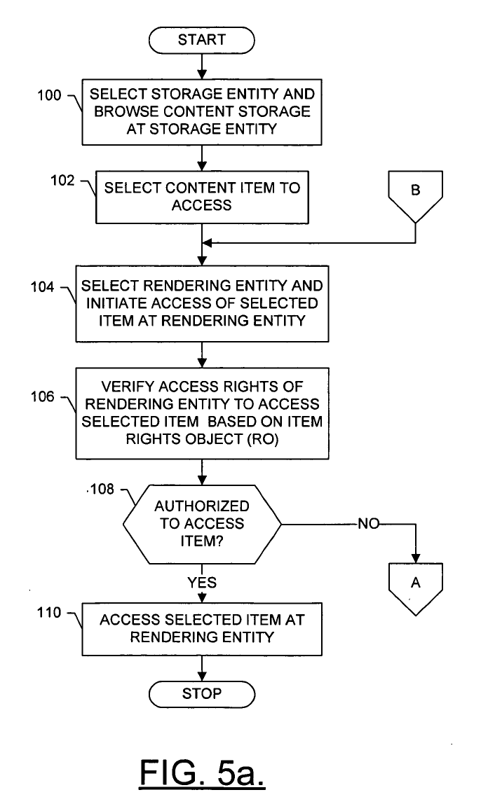

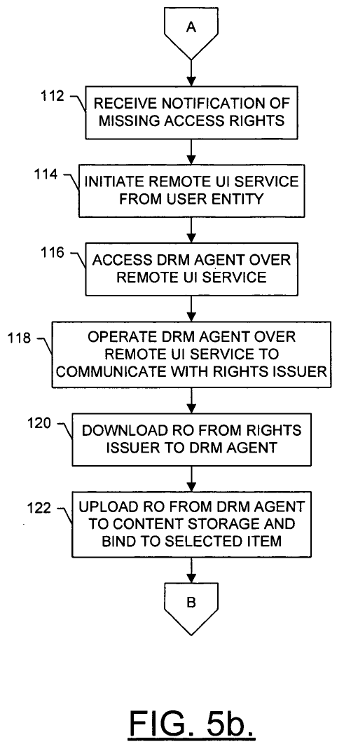

Reference is now drawn to FIGS. 4, 5a and 5b, which illustrate a functional block diagram and flowcharts of a user entity 80 selecting protected content stored by a storage entity 80 in the home network 34, the protected content being selected for rendering at a rendering entity 84. To effectuate the content selection and rendering, the user entity operates a control point 86, such as a software application, capable of receiving a user selection of a desired storage entity, a desired piece of content stored by the storage entity, and a desired rendering entity. The control point can thereafter control transfer of the selected content from the selected storage entity to the selected rendering entity for rendering by the respective rendering entity. In this regard, the storage entity can include a content storage 88, such as a memory entity, for storing content. In turn, the rendering entity includes a rendering control 90, such as a software application, for directing the rendering entity to render the selected content.

In instances where the rendering entity 84 is not authorized to render the selected content, the user entity 80, or more particularly the control point 86 of the user entity, is capable of effectuating a modification of the access rights to the selected content such that the rendering entity is thereafter authorized to render the selected content. In this regard, the control point can analyze a failure notification from the rendering entity 84 to discover a remote UI server 96 bound to a DRM agent 94, such as within a DRM entity 92. The DRM agent in such instances being capable of effectuating a modification or update of the content rights to permit the rendering entity to access, and thus render, the content. Upon discovering the remote UI server, then, the control point can communicate with the remote UI server to initiate a remote UI service over which the control point can access the DRM agent. The control point can then access the DRM agent over the remote UI service to control operation of the DRM agent to modify access rights to the selected content. More particularly, the control point can access the DRM agent to modify access rights to the selected content such that the rendering entity is authorized to render the selected content, communicating with a rights issuer 22 outside the home network 34 if necessary to effectuate such an access rights modification.

As will be appreciated, the user entity 80, storage entity 82, rendering entity 84 and DRM entity 92 can comprise any of a number of different network entities that are capable of performing the functions described herein. For example, the user entity and storage entity can comprise one or more media servers 36 within a home network 34, while the rendering entity comprises a media player 38 within the home network and the DRM entity comprises a terminal 10 capable of operating within the home network. Also, as described herein, the various entities can communicate with one another in any of a number of different manners. In one embodiment, for example, the user entity, storage entity, rendering entity and DRM entity communicate with one another within the home network in accordance with the UPnP architecture, while the DRM entity communicates with a rights issuer outside the home network in accordance with the Session Initiation Protocol (SIP) and/or Hypertext Transport Protocol (HTTP) architecture. The DRM entity can thereby operate as an UPnP-SIP and/or UPnP-HTTP proxy to and/or from the home network in various instances.

In addition, whereas the control point 86, rendering control 90, DRM agent 94 and remote UI server 96 can each comprise software operated by the respective entities, one or more of the control point, rendering control, DRM agent or remote UI server can alternatively comprise firmware or hardware. In addition, it should also be understood that one or more of the control point, rendering control, DRM agent or remote UI server can additionally or alternatively be operated from a network entity other than the entity shown and principally described herein as operating the respective applications. For example, the user entity 80 can operate a remote UI server in addition to, or in lieu of, the DRM entity 92.

Referring now to FIGS. 5a and 5b, a method of accessing protected content includes the user entity 80 operating the control point 86 to select or receive a selection of a storage entity 82, as shown in block 100. After selecting a storage entity, the control point can browse content storage 88 of the storage entity to identify a desired content item. Irrespective of whether the control point browses content storage of the storage entity, however, the control point selects a desired content item from content storage of the storage entity after selecting the respective storage entity, as shown in block 102. The desired storage entity and/or content item can be selected in any of a number of different manners. For example, the content stored by one or more storage entities may be visible to the control point via a content directory service. In this regard, the content directory service can be configured based upon one or more parameters (e.g., metadata tags) associated with the exposed content items, where the parameter(s) may be stored with the content in content storage of the storage entity. For example, a content item in the content directory can be associated with a content information metadata tag (e.g., ContentInfo) that has a uniform resource identifier (URI) employed to assist the control point in providing additional information about the respective content item. The URI, then, can point to the DRM agent 94 or remote UI server 96 capable of providing additional information about the content item, or otherwise obtaining such additional information from a provider 23 of the respective content item. Similarly, for example, a content item can be associated with a rights information metadata tag (e.g., RightsInfo) that has a URI employed to assist the control point in documenting the rights and the renewal of the allowed use of the respective content item. The URI provided by the rights information tag can point to the DRM agent or remote UI server capable of providing information about the rights and renewal of the allowed use of the content item, or otherwise obtaining such information from a respective rights issuer 22.

Before, after or as the control point 86 of the user entity 80 selects the storage entity 88, the control point selects a rendering entity 84 with which to access content. Then, after selecting the desired content item, the rendering control 90 of the rendering entity attempts to access the selected item from content storage 88 of the storage entity 82, as shown in block 104. Before rendering the selected item at the rendering entity, the rendering control verifies access rights of the rendering entity to thereby access, and thus render, the selected item, as shown in blocks 106 and 108. The access rights can be verified in any of a number of different manners, typically depending on the protection of the selected item to unauthorized access. For example, the rendering control can verify access rights of the rendering entity based upon a rights object (RO) associated with the selected item, as such is defined by the Open Mobile Alliance (OMA) Digital Rights Management specification. Alternatively, for example, the rendering control can verify access rights of the rendering entity during the security handshake with the storage entity as defined by the Digital Transmission Content Protection over Internet Protocol (DTCP/IP). In such instances, the access rights or rights object of a content item defines the permissions and constraints for use of the item. Thus, the rendering control can verify that the selected item has an associated rights object and, if so, that the rights object includes a permission for the rendering entity to render the selected item. Further, in addition to the access rights, the content can also be associated with DRM system information from which a remote UI server bound to the DRM system protecting that content should the access rights be updated and/or transferred to another network entity.

If the rendering control 90 of the rendering entity 84 successfully verifies access rights of the rendering entity, the rendering control thereafter accesses the selected item from content storage 88 of the storage entity 82 for rendering by the rendering entity, as shown in block 110. Otherwise, if the rendering control fails to verify access rights of the rendering entity, the rendering control notifies the control point 86 of the user entity 80 of the failure, as shown in block 112. In addition, if so desired, the rendering control may also indicate, to the control point, the DRM system information as well as the missing permissions required for the rendering entity to access, and thus render, the selected item. As explained below, then, the control point can utilize this information to locate a DRM agent that can modify the access rights to permit the rendering entity to access, and thus render, the content.

Accordingly, upon being notified of the failure to verify access rights of the rendering entity 84, the control point 86 of the user entity 80 communicates with a DRM agent 94 of a DRM entity 92 to attempt to effectuate a modification of the rights object to include the missing permissions required for the rendering entity to access, and thus render, the selected item. In accordance with embodiments of the present invention, the DRM agent is accessible to the control point over a remote UI service provided by a remote UI server 96. Thus, after receiving the notification, the control point identifies a DRM agent based upon the DRM system information, and discovers a remote UI server 96 bound to that DRM agent, such as within a DRM entity. The control point then communicates with the remote UI server to thereby initiate a remote UI service, as shown in block 114. The remote UI server then exposes, to the control point, the DRM agent as well as any other entities, applications or the like that are accessible over the remote UI service. The control point then selects or receives a selection of the DRM agent to initiate access to the DRM agent over the remote UI service, as shown in block 116.

After accessing the DRM agent 94 over the remote UI service, the DRM agent can attempt to modify the rights object of the selected content to include the missing permissions required for the rendering entity 84 to access, and thus render, the selected item. In various instances, the DRM agent may have authority, such as from a rights issuer 22, to directly modify the rights object to include the missing permissions. In such cases, the control point can operate the DRM agent over the remote UI service to directly modify the rights object. In other instances, however, the DRM agent may be required to communicate with the rights issuer to modify the rights object. In these instances, the control point operates the DRM agent over the remote UI service to initiate communication with the rights issuer, as shown in block 118. Thereafter, the control point communicates with the rights issuer via the DRM agent to modify the rights object to include the missing permissions, such as by downloading a modified rights object that includes such permissions, as shown in block 120. After downloading the modified rights object from the rights issuer to the DRM agent, the control point operates the DRM agent to upload the modified rights object to the content storage 88 of the storage entity 82 such that the modified rights object is bound to or otherwise associated with the selected content item, as shown in block 122.

After the modified rights object is associated with the selected content item, the control point 86 of the user entity 80 again selects the rendering entity 84 with which to access content. Accordingly, the rendering control 90 of the rendering entity again attempts to access the selected item from content storage 88 of the storage entity 82, as shown in block 104. As before, the rendering control verifies access rights of the rendering entity to access, and thus render, the selected item, as shown in blocks 106 and 108. More particularly, for example, the rendering control verifies access rights of the rendering entity based upon the modified rights object associated with the selected item. As the rights object now includes permissions for the rendering entity to access, and thus, render the selected content, the rendering control can successfully verify access rights of the rendering entity. Thus, the rendering control can access the selected item from content storage 88 of the storage entity 82 for rendering by the rendering entity, as shown in block 110.

As explained above, the control point 86 accesses and operates the DRM agent 94 over a remote UI service to modify the rights object of a selected content item to add permissions for a rendering entity 84 to access the selected content item. It should be understood, however, that the control point can additionally or alternatively access and operate the DRM agent over the remote UI service for a number of other purposes without departing from the spirit and scope of the present invention. For example, the control point can operate the DRM agent to bind or otherwise associate a rights object to one or more content items in instances where the rights object and content item(s) are stored at different locations. Additionally or alternatively, for example, the control point can operate the DRM agent to add, delete or otherwise modify permissions in one or more rights objects for adding, deleting or otherwise modifying the entities authorized to access respective content items. Further, for example, the control point can operate the DRM agent to add, delete or otherwise modify constraints in one or more rights objects for adding, deleting or otherwise modifying constraints on entities otherwise authorized to access respective content items.

As explained above, the DRM agent 94 located within the home network 34 is capable of directly communicating with the rights issuer 22 located outside the home network. In various instances, however, the DRM agent may not be configured to communicate outside the home network. In such instances, the home network can further include a DRM GTW (e.g., GTW 18) capable of interfacing between the DRM agent within the home network and the rights issuer outside the home network, the DRM GTW thereby operating as the UPnP-SIP and/or UPnP-HTTP proxy to and/or from the home network. When so required, then, the DRM agent can first discover an appropriate DRM GTW, and thereafter communicate with the rights issuer via the discovered DRM GTW.

According to one aspect of the present invention, all or a portion of the system of the present invention, such as all or portions of the user entity 80, storage entity 82, storage entity 84, DRM entity 92 and/or rights issuer 22, generally operates under control of a computer program product (e.g., control point 86, rendering control 90, DRM agent 94, remote UI server 96, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 5a and 5b are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for accessing protected content within an intranet, the system comprising:
a remote UI server capable of providing the remote user interface (UI) service;
a user entity capable of interpreting digital rights management (DRM) information associated with a selected content item to initiate discovery of the remote UI server, and thereafter capable of initiating the UI service with the remote UI server; and
a DRM agent capable of being accessed from the user entity over the remote UI service, the DRM agent being located across the intranet from the user entity,
wherein the user entity is capable of operating the accessed DRM agent over the remote UI service to thereby effectuate a modification of a rights object associated with the selected content item, the rights object being modified such that the selected content item can thereafter be accessed based upon the modified rights object.

2. A system according to claim 1, wherein the user entity is capable of operating the DRM agent to download a modified rights object from a rights issuer, and thereafter bind the downloaded rights object to the selected content item.

3. A system according to claim 2, wherein the user entity, remote UI server and DRM agent are located within the intranet, and wherein the system further comprises:
a rights issuer located outside the intranet, the rights issuer being capable of communicating with the DRM agent,
wherein the user entity is capable of operating the DRM agent to download a modified rights object from a rights issuer located outside the intranet.

4. A system according to claim 3, wherein the user entity is capable of operating the DRM agent to download a modified rights object from the rights issuer in accordance with at least one of a Session Initiation Protocol (SIP) architecture or a Hypertext transfer protocol (HTTP) architecture, and
wherein the user entity is capable of operating the DRM agent to upload the downloaded rights object to content storage located within the intranet in accordance with one of a Digital Living Network Alliance (DLNA) architecture or a Universal Plug-and-Play (UPnP) architecture.

5. A system according to claim 1 further comprising:
an entity capable of verifying access rights of the entity with respect to the selected content item based upon the modified rights object, and if the access rights are verified, accessing the selected content item at the entity.

6. A system according to claim 5, wherein the user entity is capable of operating the DRM agent to bind the modified rights object to the selected content item in a content storage located across the intranet from the entity, and
wherein the entity is capable of accessing the selected content item at the entity from the content storage, and
wherein the selected content item is stored in content storage along with at least one metadata tag including a uniform resource identifier (URI) pointing to the remote UI server, the remote UI server being associated with the DRM agent.

7. A digital rights management (DRM) entity for facilitating access to protected content within an intranet, the DRM entity comprising:
a remote user interface (UI) server capable of providing a remote (UI) service to a control point; and
a digital rights management (DRM) agent capable of being accessed from the control point over the remote UI service,
wherein the DRM agent is capable of being operated from the control point over the remote UI service to thereby effectuate a modification of a rights object associated with a selected content item, the rights object being modified such that the selected content item can thereafter be accessed based upon the modified rights object.

8. A DRM entity according to claim 7, wherein the DRM agent is capable of being operated to download a modified rights object from a rights issuer, and thereafter bind the downloaded rights object to the selected content item.

9. A DRM entity according to claim 8, wherein the DRM entity and control point are located within the intranet, and wherein the DRM agent is capable of being operated to download a modified rights object from a rights issuer located outside the intranet.

10. A DRM entity according to claim 9, wherein the DRM agent is capable of being operated to download a modified rights object from the rights issuer in accordance with at least one of a Session Initiation Protocol (SIP) architecture or a Hypertext transfer protocol (HTTP) architecture, and
wherein the DRM agent is capable of being operated to upload the downloaded rights object to content storage located within the intranet in accordance with one of a Digital Living Network Alliance (DLNA) architecture or a Universal Plug-and-Play (UPnP) architecture.

11. A DRM entity according to claim 7, wherein the DRM agent is capable of being operated to effectuate a modification of the rights object such that an entity is capable of verifying access rights of the entity with respect to the selected content item based upon the modified rights object, and if the access rights are verified, accessing the selected content item.

12. A DRM entity according to claim 11, wherein the DRM agent is capable of being operated to bind the modified rights object to the selected content item in a content storage located across the intranet from the entity, and
wherein the DRM agent is capable of being operated to effectuate a modification of the rights object such that the entity is capable of accessing the selected content item from the content storage.

13. A user entity for facilitating access to protected content within an intranet, the user entity comprising:
a control point capable of initiating a remote user interface (UI) service,
wherein the control point is capable of accessing a digital rights management (DRM) agent over the remote UI service, the DRM agent being located across the intranet from the control point, and
wherein the control point is capable of operating the accessed DRM agent over the remote UI service to thereby effectuate a modification of a rights object associated with a selected content item, the rights object being modified such that the selected content item can thereafter be accessed based upon the modified rights object.

14. A user entity according to claim 13, wherein the control point is capable of operating the DRM agent to download a modified rights object from a rights issuer, and thereafter bind the downloaded rights object to the selected content item.

15. A user entity according to claim 14, wherein the control point and DRM agent are located within the intranet, and wherein the control point is capable of operating the DRM agent to download a modified rights object from a rights issuer located outside the intranet.

16. A user entity according to claim 15, wherein the control point is capable of interpreting DRM information associated with a selected content item to initiate discovery of a remote UI server, and thereafter capable of initiating the UI service with the remote UI server,
wherein the control point is capable of operating the DRM agent over the remote UI service to download a modified rights object from the rights issuer in accordance with at least one of a Session Initiation Protocol (SIP) architecture or a Hypertext transfer protocol (HTTP) architecture, and
wherein the control point is further capable of operating the DRM agent to upload the downloaded rights object to content storage located within the intranet in accordance with one of a Digital Living Network Alliance (DLNA) architecture or a Universal Plug-and-Play (UPnP) architecture.

17. A user entity according to claim 13, wherein the control point is capable of operating the DRM agent to effectuate a modification of the rights object such that an entity is capable of verifying access rights of the entity with respect to the selected content item based upon the modified rights object, and if the access rights are verified, accessing the selected content item.

18. A user entity according to claim 17, wherein the control point is capable of operating the DRM agent to bind the modified rights object to the selected content item in a content storage located across the intranet from the entity, and
wherein the control point is capable of operating the DRM agent to effectuate a modification of the rights object such that the entity is capable of accessing the selected content item from the content storage.

19. A method of accessing protected content within an intranet, the method comprising:
initiating a remote user interface (UI) service from a control point;
accessing a digital rights management (DRM) agent from the control point over the remote UI service, the DRM agent being located across the intranet from the control point; and
operating the accessed DRM agent from the control point over the remote UI service to thereby effectuate a modification of a rights object associated with a selected content item, the rights object being modified such that the selected content item can thereafter be accessed based upon the modified rights object.

20. A method according to claim 19, wherein the operating step includes operating the DRM agent to download a modified rights object from a rights issuer, and thereafter bind the downloaded rights object to the selected content item.

21. A method according to claim 20, wherein the control point and DRM agent are located within the intranet, and wherein the operating step includes operating the DRM agent to download a modified rights object from a rights issuer located outside the intranet.

22. A method according to claim 21, wherein the operating step includes operating the DRM agent to download a modified rights object from the rights issuer in accordance with at least one of a Session Initiation Protocol (SIP) architecture or a Hypertext transfer protocol (HTTP) architecture, and
wherein the operating step further includes operating the DRM agent to upload the downloaded rights object to content storage located within the intranet in accordance with one of a Digital Living Network Alliance (DLNA) architecture or a Universal Plug-and-Play (UPnP) architecture.

23. A method according to claim 19 further comprising:
verifying access rights of an entity with respect to the selected content item based upon the modified rights object; and if the access rights are verified,
accessing the selected content item at the entity.

24. A method according to claim 23, wherein the operating step includes operating the DRM agent to bind the modified rights object to the selected content item in a content storage located across the intranet from the entity, and
wherein the accessing step comprises accessing the selected content item at the entity from the content storage.

25. A computer program product for facilitating access to protected content within an intranet, the computer program product comprising at least one computer-readable storage medium having computer-readable program code portions stored therein, the computer-readable program code portions comprising:
a first executable portion for initiating a remote user interface (UI) service from a control point;
a second executable portion for accessing a digital rights management (DRM) agent from the control point over the remote UI service, the DRM agent being located across the intranet from the control point; and
a third executable portion for operating the accessed DRM agent from the control point over the remote UI service to thereby effectuate a modification of a rights object associated with a selected content item, the rights object being modified such that the selected content item can thereafter be accessed based upon the modified rights object.

26. A computer program product according to claim 25, wherein the third executable portion is adapted to operate the DRM agent to download a modified rights object from a rights issuer, and thereafter bind the downloaded rights object to the selected content item.

27. A computer program product according to claim 26, wherein the control point and DRM agent are located within the intranet, and wherein the third executable portion is adapted to operate the DRM agent to download a modified rights object from a rights issuer located outside the intranet.

28. A computer program product according to claim 27, wherein the third executable portion is adapted to operate the DRM agent to download a modified rights object from the rights issuer in accordance with at least one of a Session Initiation Protocol (SIP) architecture or a Hypertext transfer protocol (HTTP) architecture, and
wherein the third executable portion is further adapted to operate the DRM agent to upload the downloaded rights object to content storage located within the intranet in accordance with one of a Digital Living Network Alliance (DLNA) architecture or a Universal Plug-and-Play (UPnP) architecture.

29. A computer program product according to claim 25 further comprising:
a fourth executable portion for verifying access rights of an entity with respect to the selected content item based upon the modified rights object, and if the access rights are verified, accessing the selected content item at the entity.

30. A computer program product according to claim 29, wherein the third executable portion is adapted to operate the DRM agent to bind the modified rights object to the selected content item in a content storage located across the intranet from the entity, and
wherein the fourth executable portion is adapted to access the selected content item at the entity from the content storage.
